(19) United States
(12) Patent Application Publication
(10) Pub. No.: US 2019/0075961 A1
(43) Pub. Date: Mar. 14, 2019

(54) CUP STAND

(71) Applicant: ONA COFFEE WHOLESALE(CANBERRY)PTY LTD, ACT (AU)

(72) Inventor: Sasa Sestic, ACT (AU)

(73) Assignee: ONA COFFEE WHOLESALE(CANBERRY)PTY LTD

(21) Appl. No.: 16/004,165

(22) Filed: Jun. 8, 2018

(30) Foreign Application Priority Data
Sep. 12, 2017 (TW) 106131167

(51) Int. Cl. A47J 31/44; F16M 11/28; A47J 31/41

(52) U.S. Cl. CPC A47J 31/441; A47J 31/41; F16M 11/28

(57) ABSTRACT

A cup stand for holding a cup including a base, a carrier, and a positioning device. The base has a base member and a first connecting member connected to the base member, and the carrier has a carrier member and a second connecting member connected to the carrier member. The second connecting member of the carrier is movably connected to the first connecting member of the base, and the first connecting member is fixed to the second connecting member through the positioning device when the carrier member is moved to a predetermined height.

### BACKGROUND OF THE INVENTION

### 1. Technical Field

The present invention relates to an accessory of making tea or coffee, and more particularly to a cup stand for holding a cup and measuring the content in the cup.

### 2. Description of Related Art

To make a good coffee, the quality of coffee beans, temperature and quantity of water, and so on are the important facts, which effects flavor of coffee.

Temperature and quantity of water could be set in consistent if a coffee machine is applied to make coffee. When the coffee is made by man, the inconsistence of coffee flavor is enlarged. In some studies, it has about 10%-20% differences in the coffee made by man. It is not good for a store which is asked to serve the consistent coffee.

Today, more and more people like hand-made coffee. However, even an experienced barista can't make a consistent flavor for every cup of coffee. So that the hand-made coffee usually have different flavor.

### BRIEF SUMMARY OF THE INVENTION

The primary objective of the present invention is to provide a cup stand, which may hold a cup and works with a measuring device to check the facts of water to make coffee.

The secondary objective of the present invention is to provide a cup stand, which is adjustable for the height to match various brewing devices.

The third objective of the present invention is to provide a cup stand, which may isolate the measuring device from water to avoid short in operation of the measuring device.

In order to achieve above objectives, the present invention provides a cup stand for holding a cup including a base, a carrier, and a positioning device. The base has a base member and a first connecting member connected to the base member, and the carrier has a carrier member and a second connecting member connected to the carrier member. The second connecting member of the carrier is movably connected to the first connecting member of the base, and the positioning device connects the first connecting member to the second connecting member. The first connecting member is fixed to the second connecting member through the positioning device when the carrier member is moved to a predetermined height.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

FIG. 1 is a perspective view of a first preferred embodiment of the present invention;

FIG. 2 is an exploded view of the first preferred embodiment of the present invention;

FIG. 3 is another perspective view of the first preferred embodiment of the present invention;

FIG. 4 is an exploded view of the alternate carrier member the first preferred embodiment of the present invention;

FIG. 5 is a perspective view of a second preferred embodiment of the present invention;

FIG. 6 is a perspective view of a third preferred embodiment of the present invention;

FIG. 7 is a perspective view of a fourth preferred embodiment of the present invention;

FIG. 8 is a perspective view of a fifth preferred embodiment of the present invention;

FIG. 9 is a perspective view of the fifth preferred embodiment of the present invention, showing the alternate fast release;

FIG. 10 is a perspective view of a sixth preferred embodiment of the present invention;

FIG. 11 is an exploded view of a seventh preferred embodiment of the present invention;

FIG. 12 is a perspective view of the seventh preferred embodiment of the present invention; and

FIG. 13 is a sketch diagram of the seventh preferred embodiment of the present invention, showing the base connected to the measuring device.

### DETAILED DESCRIPTION OF THE INVENTION

The present invention will be clearer from the following description when viewed together with the accompanying drawings, which show, for purpose of illustrations only, the preferred embodiment in accordance with the present invention.

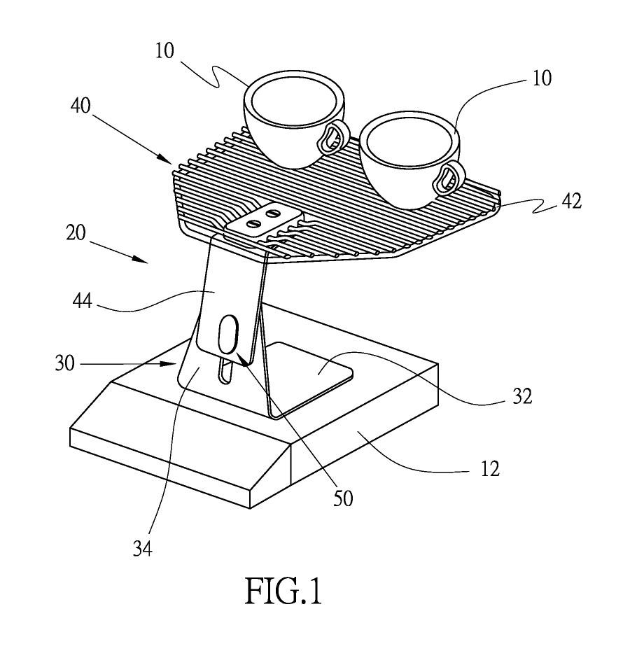

Referring to FIG. 1, a cup stand 20 of the first preferred embodiment of the present invention is to put cups 10 thereon in association with a brewing device (not shown). The cup stand 20 is configured to be put on a measuring device 12, which is an electronic scale in the present embodiment to measure a weight of liquid in the cups 20. The liquid in the cups 20 could be tea, coffee, alcohol, water, and the like.

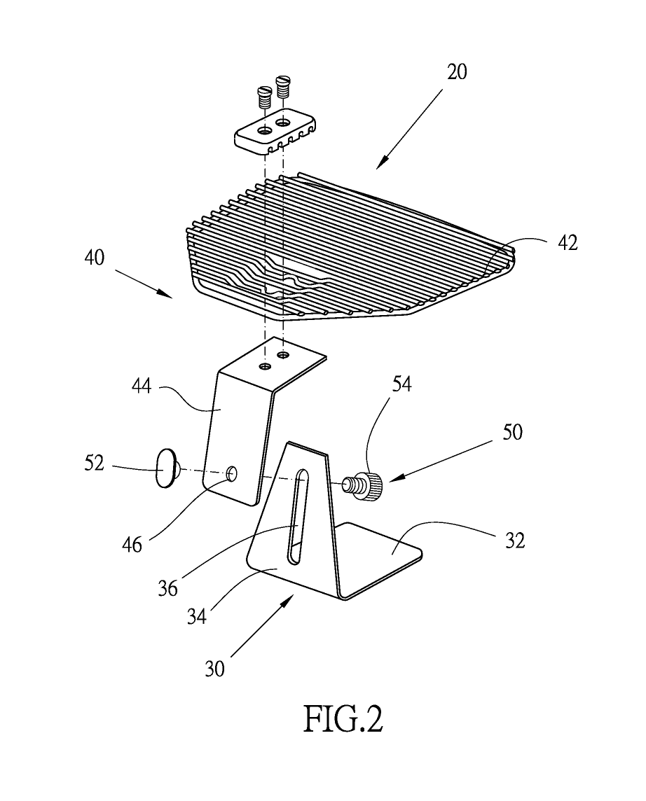

As shown in FIG. 1 and FIG. 2, the cup stand 20 includes a base 30, a carrier 40, and a positioning device 50. The base 30 has a base member 32 with a first connecting member 34. The carrier 40 has a carrier member 42 with a second connecting member 44 to be connected to the first connecting member 34 of the base member 32 through the positioning device 50.

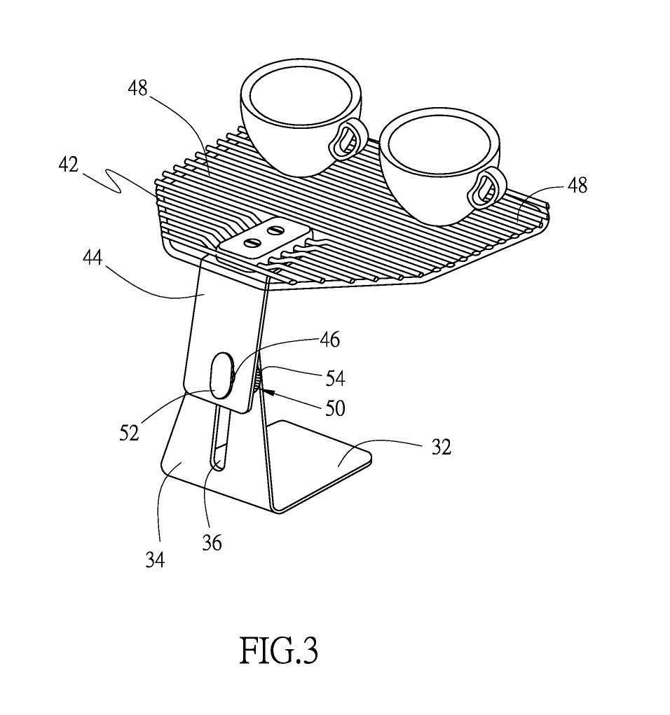

As shown in FIG. 2 and FIG. 3, the first connecting member 34 is a plate having an elongated adjusting hole 36 thereon. The second connecting member 44 is a plate as well having a positioning bore 46 thereon. The positioning device 50 has a nut 52 and a fastener 54 (a bolt). The nut 52 has a protrusion passing through the positioning bore 46 and the adjusting hole 36 in sequence to be secured with the fastener 54 that could fixedly connect the first connecting member 34 to the second connecting member 44.

As shown in FIG. 3, loosing the fastener 54 may shift the first connecting member 34 related to the second connecting member 44 that could change a height of the carrier member 42, and then the fastener 54 is fastened again to fix the carrier member 42 at that height. It could make the cup stand 20 of the present invention work with any type of brewing device and working table. The carrier member 42 of the carrier 42 has a porous portion, which is a net constructed by a plurality of metallic wires to form bores 48 between the wires.

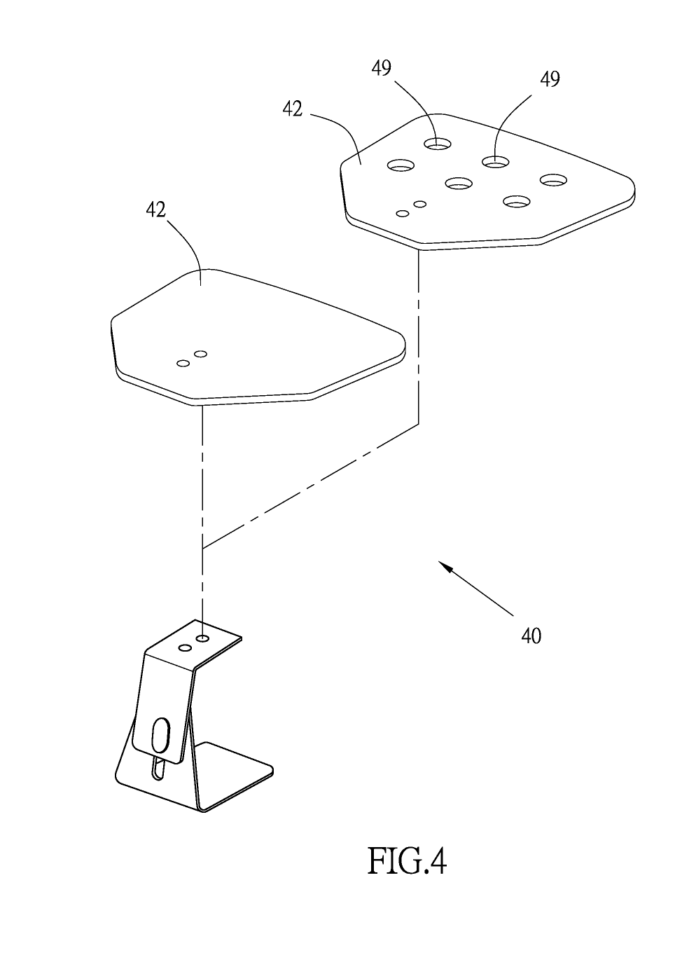

As shown in FIG. 4, the carrier member 42 of the carrier 42 is a flat board, or a flat board with a plurality of bores 49.

The bores 48, 49 shown in FIG. 3 and FIG. 4 may discharge liquid out of the carrier member 42 to keep clean on the carrier member 42.

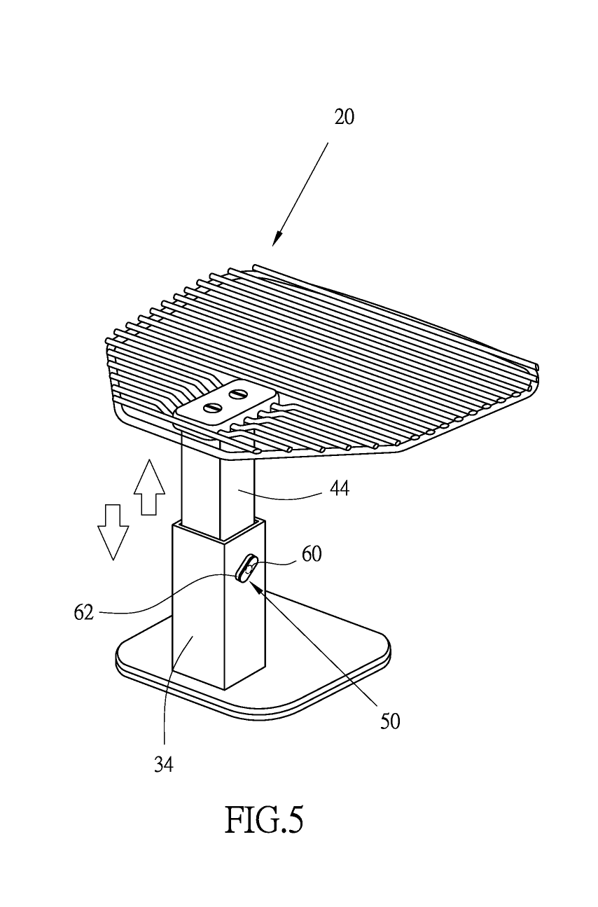

As shown in FIG. 5, the first connecting member 34 of the base member 32 is a rectangular tubular member, and the second connecting member 44 of the carrier member 42 is a rectangular tubular member as well. The second connecting member 44 is inserted into the first connecting member 34. The first connecting member 34 is provided with an adjusting hole 60, which is a threaded hole. The positioning device 50 has a fastener 62 screwed into the adjusting hole 60 and pressing the second connecting member 44 to secure the first and the second connecting members 34, 44 with a predetermined length.

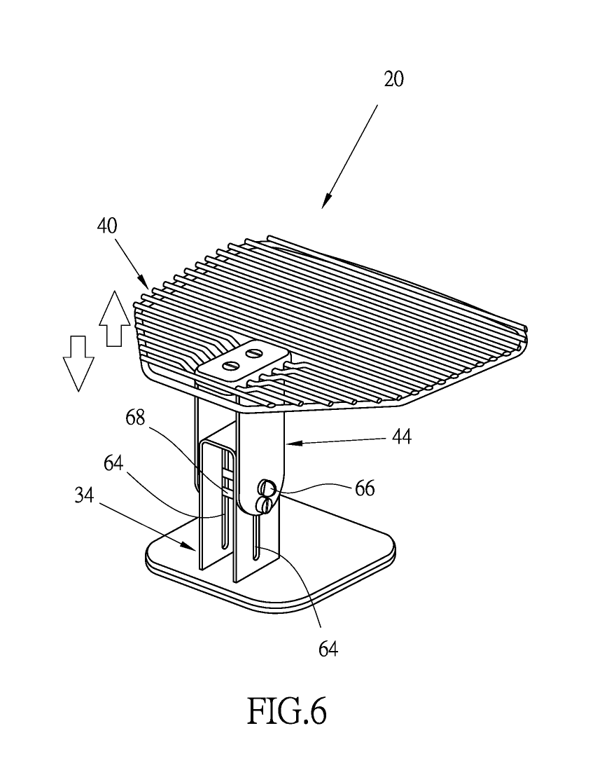

As shown in FIG. 6, the first connecting member 34 of the base member 32 is a rail, which is a U-shaped member with a pair of parallel plates, and each of the plates has an elongated adjusting hole 64. The second connecting member 44 of the carrier member 42 has two parallel plates, and each of the plates has a positioning bore (not shown). The plates of the second connecting member 44 are attached to outer sides of the plates of the first connecting member 34. The positioning device 50 has a fastener 66, a nut (not shown), and a pin 68. The fastener 66 is inserted into the positioning bores of the second connecting member 44 and the adjusting holes 64 of the first connecting member 34, and engages the nut at the opposite side. The pin 68 is inserted into the positioning bores of the second connecting member 44 and the adjusting holes 64 of the first connecting member 34. The fastener 66 and the nut serve the function of securing the first and the second connecting members 34, 44 with a predetermined length, and the pin 68 serve the function of prevent the carrier 40 from leaning.

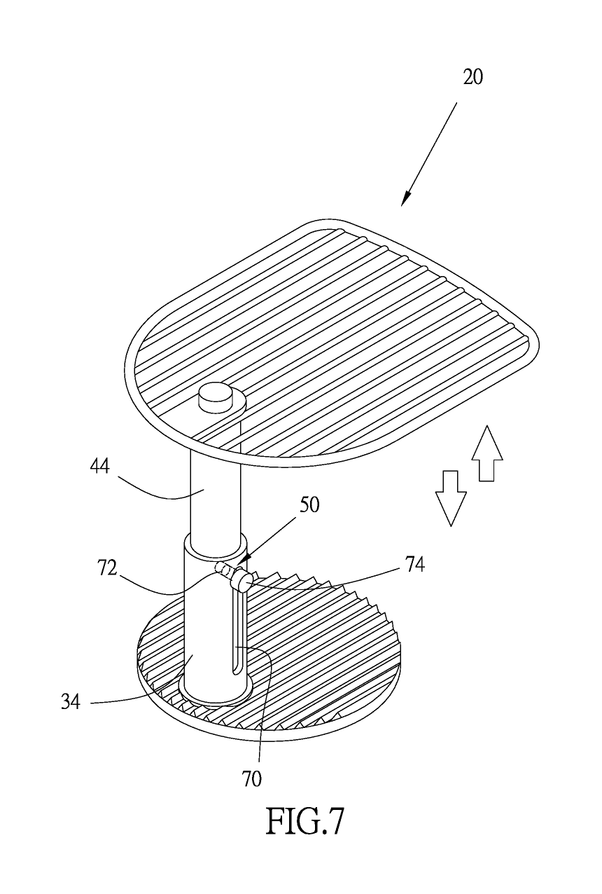

As shown in FIG. 7, the first connecting member 34 of the base member 32 is a round tubular member, and the second connecting member 44 of the carrier member 42 is a round tubular member as well. The second connecting member 44 is inserted into the first connecting member 34. The first connecting member 34 is provided with an elongated adjusting hole 70, and the second connecting member 44 is a plurality of positioning holes 72. The positioning device 50 has a pin 74 inserted into the adjusting hole 60 and one of the positioning holes 72 to secure the first and the second connecting members 34, 44 with a predetermined length.

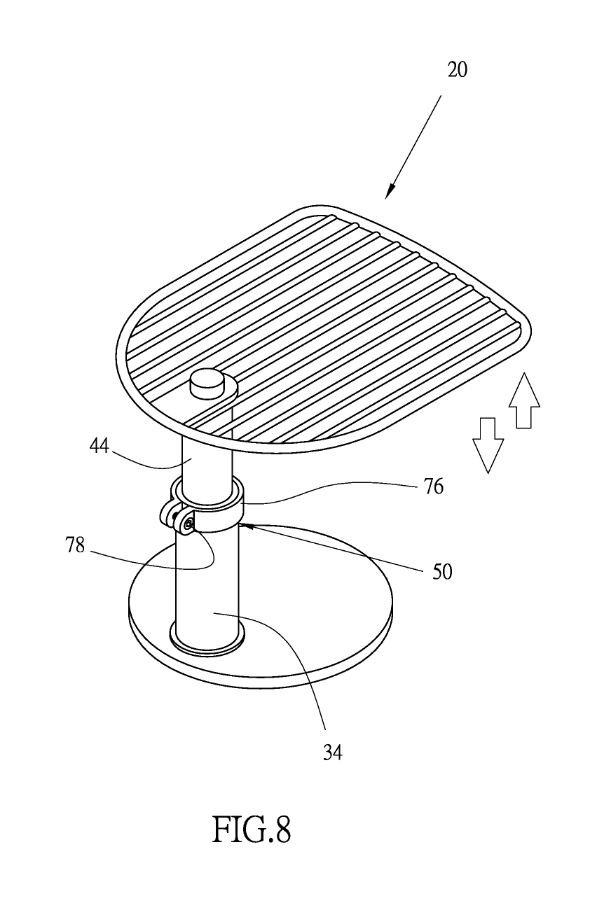

As shown in FIG. 8, the first connecting member 34 of the base member 32 is a round tubular member, and the second connecting member 44 of the carrier member 42 is a round tubular member as well. The second connecting member 44 is inserted into the first connecting member 34. The positioning device 50 has a C-ring 76 and a fastener 78. The C-ring 76 is fitted to the first connecting member 34 to be narrowed by tightening the fastener 78.

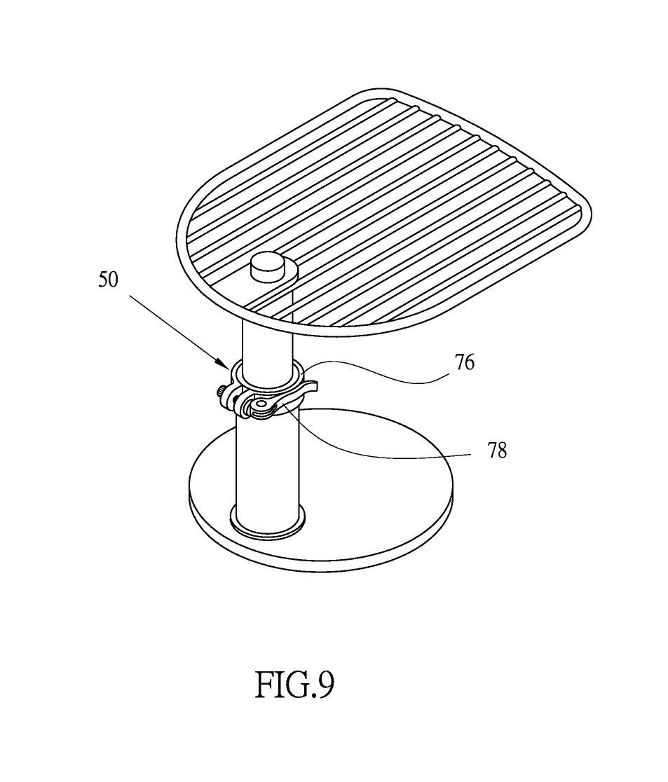

As shown in FIG. 9, the first connecting member 34 of the base member 32 is a round tubular member, and the second connecting member 44 of the carrier member 42 is a round tubular member as well. The second connecting member 44 is inserted into the first connecting member 34. The positioning device 50 has a C-ring 76 and a quick release 78. The C-ring 76 is fitted to the first connecting member 34 to be narrowed by tightening the quick release 78.

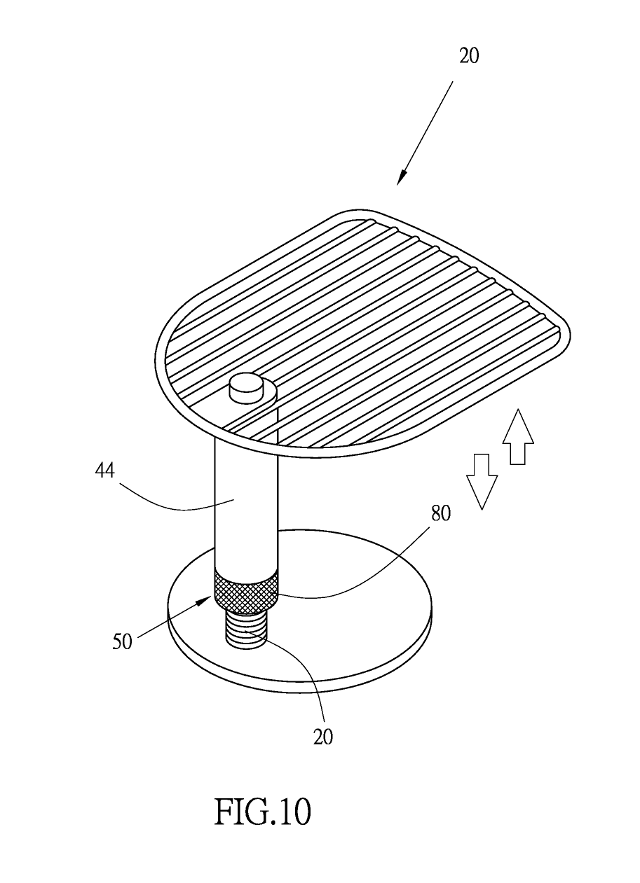

As shown in FIG. 10, the first connecting member 34 of the base member 32 is a screw rod, and the second connecting member 44 of the carrier member 42 is a round tubular member. The positioning device 50 has nut 80 fixed to the second connecting member 44. The screw rod is screwed into the nut 80 and the tubular member of the first connecting member 34. As a result, the carrier 40 is turned to adjust a height of the carrier member 42. The nut 80 could be replaced by a threaded hole (not shown) in the second connecting member 44, and the screw rod of the first connecting member 34 engages the threaded hole of the second connecting member 44 instead.

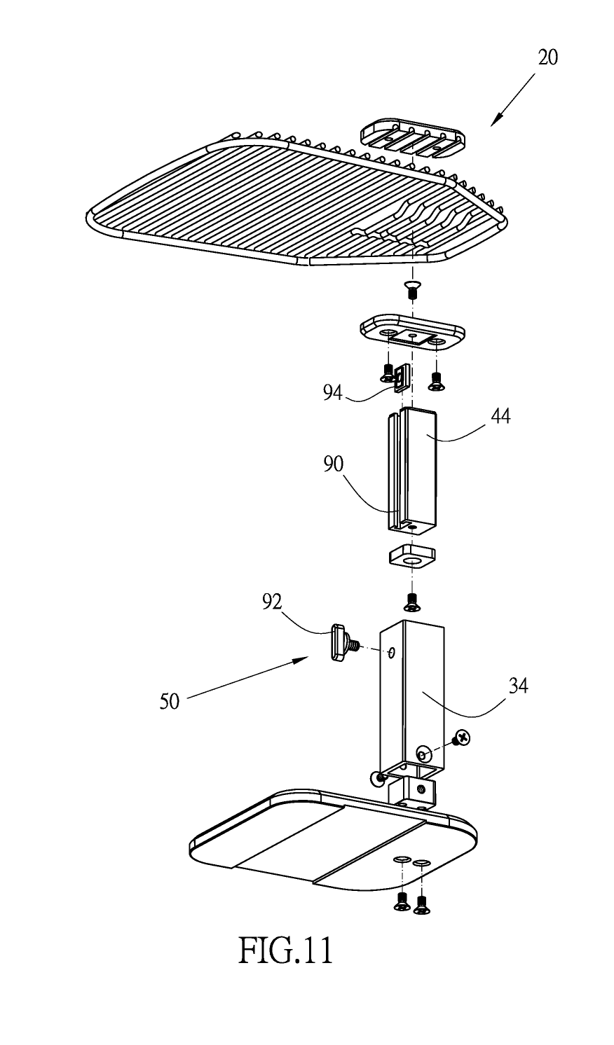

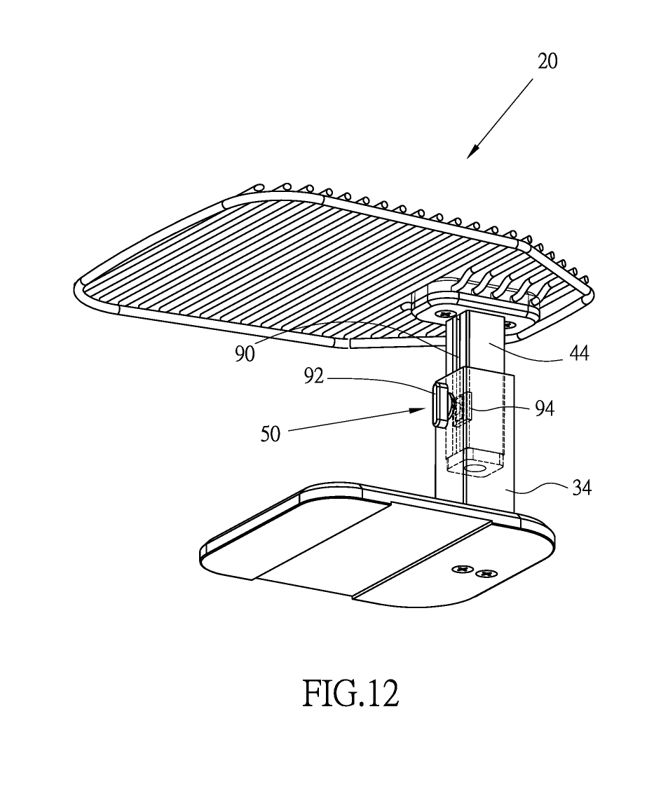

As shown in FIG. 11 and FIG. 12, the first connecting member 34 of the base member 32 is a rectangular tubular member, and the second connecting member 44 of the carrier member 42 is rectangular rod. The rod of the second connecting member 44 has a slot 90. The positioning device 50 includes a fastener 92 and a plate 94.

The plate 94 has a threaded hole, and is received in the slot 90 of the second connecting member 44. The fastener 92 is inserted into a hole on the first connecting member 34, and screwed into the threaded hole of the plate 90.

The carrier 40 is able to be moved up and down along the first connecting member 34 by loosing the fastener 92, and the fastener 92 is tightened to secure the first and the second connecting members 34, 44 when the carrier member 42 is moved to a desired height.

According to the embodiments as described above, the carrier member 42 is able to be moved to a desired height by operating the positioning device 50 to apply the cup stand 20 to different brewing device.

In addition, the base member 32 of the base 30 may be incorporated with a measuring device to measure the properties of the cups put on the carrier member 42.

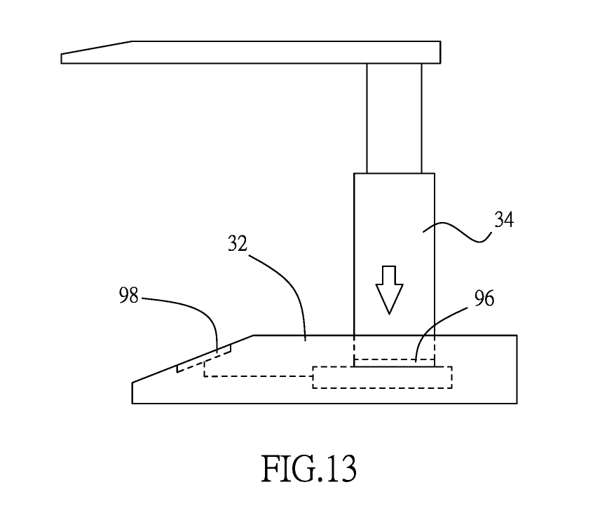

As shown in FIG. 13, the base member 32 of the base 30 is provided with a measuring device 96 therein, and the first connecting member 34 touches the measuring device 96. The measuring device 96 is a weight scale to measure a change of the carrier 40 through the first connecting member 34, and show the measuring result on a screen 98. The measuring device 96 could be a pressure sensor or a strain gauge.

While we have shown and described various embodiments in accordance with the present invention, it is clear to those skilled in the art that further embodiments may be made without departing from the scope of the present invention.

1. A cup stand for holding a cup, comprising:
a base having a base member and a first connecting member connected to the base member;
a carrier having a carrier member and a second connecting member connected to the carrier member, wherein the second connecting member of the carrier is movably connected to the first connecting member of the base; and
a positioning device connecting the first connecting member to the second connecting member;
wherein the first connecting member is fixed to the second connecting member through the positioning device when the carrier member is moved to a predetermined height.

2. The cup stand of claim 1, wherein the carrier member of the carrier has a flat board with a plurality of bores.

3. The cup stand of claim 1, wherein the carrier member of the carrier has a board constructed by a plurality of wires to form bores between the wires.

4. The cup stand of claim 1, wherein the first connecting member includes a plate having an elongated adjusting hole; the second connecting member includes a plate having a positioning bore; the positioning device has a nut and a fastener, wherein the nut has a protrusion passing through the positioning bore and the adjusting hole in sequence to be secured with the fastener.

5. The cup stand of claim 1, wherein the first connecting member includes a, and the second connecting member includes a tubular member; the tubular member of the second connecting member is inserted into the tubular member of the first connecting member; the first connecting member is provided with an adjusting hole; the positioning device has a fastener passing through the adjusting hole to press the second connecting member.

6. The cup stand of claim 1, wherein the first connecting member includes a rail, and the rail has a pair of elongated adjusting holes; the second connecting member includes two parallel plates attached to opposite sides of the rail; the positioning device has a fastener and a pin; the fastener passes through the plates of the second connecting member and the adjusting holes of the first connecting member to fix the plates of the second connecting member to the rail of the first connecting member; the pin passes through the plates of the second connecting member and the adjusting holes of the first connecting member.

7. The cup stand of claim 1, wherein the first connecting member includes a tubular member, and the second connecting member includes a tubular member; the tubular member of the second connecting member is inserted into the tubular member of the first connecting member; the first connecting member is provided with an elongated adjusting hole, and the second connecting member is a plurality of positioning holes; the positioning device has a pin inserted into the adjusting hole and one of the positioning holes.

8. The cup stand of claim 1, wherein the first connecting member includes a tubular member, and the second connecting member includes a tubular member; the tubular member of the second connecting member is inserted into the tubular member of the first connecting member; the positioning device has a C-ring and a fastener; the C-ring is fitted to the first connecting member to be narrowed by tightening the fastener.

9. The cup stand of claim 1, wherein the first connecting member includes a screw rod, and the second connecting member includes a tubular member; the positioning device has nut fixed to the second connecting member; the screw rod is screwed into the nut and the tubular member of the second connecting member.

10. The cup stand of claim 1, wherein the first connecting member includes a tubular member, and the second connecting member includes a rod; the rod of the second connecting member has a slot; the positioning device includes a fastener and a plate; the plate has a threaded hole, and is received in the slot of the second connecting member; the fastener is inserted into a hole on the first connecting member, and screwed into the threaded hole of the plate.
